(19) United States
(12) Patent Application Publication
(10) Pub. No.: US 2016/0333697 A1
(43) Pub. Date: Nov. 17, 2016

(54) MANUFACTURE OF BLADE CHANNELS OF TURBOMACHINE ROTORS

(71) Applicant: MTU Aero Engines AG, Munich (DE)

(72) Inventors: Wolfgang STEINERT, Odelzhausen-Taxa (DE); Adolf SEIDL, Jetzendorf (DE)

(21) Appl. No.: 15/150,721

(22) Filed: May 10, 2016

(30) Foreign Application Priority Data
May 12, 2015 (DE) 102015208784.0

(51) Int. Cl. F01D 5/14; B23P 15/00; B23P 15/02; F01D 5/02

(52) U.S. Cl. CPC F01D 5/146; F01D 5/02; B23P 15/006; B23P 15/02; F05D 2220/32; F05D 2230/10; F05D 2240/305; F05D 2240/306

(57) ABSTRACT

A method for manufacturing blade channels of turbomachine rotors, in particular gas turbine rotors, with integrated blades. The method comprises producing a multiplicity of arrangements, offset with respect to one another in a circumferential direction, of bores proceeding from a radially outer shell surface of the rotor, at least two bores of at least one arrangement being offset with respect to one another in an axial and/or circumferential direction such that said bores engage into one another and form a slot; and producing pressure and suction sides of blades by material removal in the slots.

### CROSS-REFERENCE TO RELATED APPLICATIONS

The present application claims priority under 35 U.S.C. §119 of German Patent Application No. 102015208784.0, filed May 12, 2015, the entire disclosure of which is expressly incorporated by reference herein.

### BACKGROUND OF THE INVENTION

1. Field of the Invention

The present invention relates to a method and to a machine tool for manufacturing blade channels of turbomachine rotors, in particular gas turbine rotors, with integrated blades, and to a turbomachine rotor, in particular gas turbine rotor, manufactured thereby.

2. Discussion of Background Information

In gas turbines in particular, use is made of rotors with integrated blades, so-called BLISKs (“Blade Integrated diSKs”, also “integrally bladed rotor” IBR).

In accordance with in-house practice, blade channels of such BLISK s are manufactured by way of computer-controlled cutting machines, in particular by way of milling, preferably trochoid milling, or by way of offset bores in the throughflow or longitudinal direction of the blade channels.

It would be advantageous to have available turbomachine rotors, in particular gas turbine rotors, which have integrated blades which are defined or separated from one another by blade channels.

### SUMMARY OF THE INVENTION

The present invention provides a method for manufacturing blade channels of a turbomachine rotor, in particular a gas turbine rotor, with integrated blades. The method comprises producing a multiplicity of arrangements, which are offset with respect to one another in a circumferential direction, of bores proceeding from a radially outer shell surface of the rotor, at least two bores of at least one arrangement being offset with respect to one another in an axial and/or circumferential direction such that said bores engage into one another and form a slot; and producing pressure and suction sides of blades by material removal in the slots.

In one aspect of the method, a radial height of at least one of the produced bores may amount to at least 75%, e.g., at least 90% of a blade height of an adjacent pressure and/or suction side of the blades.

In another aspect of the method, a spacing of at least one of the bores in the circumferential direction from an adjacent pressure side and from an adjacent suction side may differ by at most 10%.

In yet another aspect of the method, a diameter of at least one of the bores may be at least 30%, in particular at least 50%, and/or at most 90%, in particular at most 85%, of a minimum spacing in a circumferential direction between an adjacent pressure side and suction side.

In a still further aspect, at least two bores of at least one of the arrangements may have the same diameter or different diameters.

In another aspect, cross sections of at least two adjacent bores of at least one of the arrangements may overlap one another by at least 10% and/or at most 90%.

In another aspect, a drilling axis of a drilling tool during the production of at least one of the bores may be inclined by at most 35°, in particular at most 15°, with respect to a radial direction of the rotor.

In another aspect, at least one of the bores may be produced in a single working step.

In another aspect, a bore that is produced first in at least one of the arrangements may be produced so as to be spaced apart, in particular at least substantially equally, in an axial direction from mutually oppositely situated face sides of the rotor.

In another aspect, at least one of the slots formed by the bores that engage into one another may be open in the axial direction toward one or both of the mutually oppositely situated face sides of the rotor.

In another aspect of the method, firstly, at least two slots that are adjacent in the circumferential direction may be formed by way of the bores that engage into one another, and subsequently, the pressure side and suction side of a blade may be produced by material removal in said slots.

In another aspect, the pressure side and/or suction side of at least one of the blades may be produced by repeated material removal, and/or material removal blockwise in a radial direction, in the slots.

In another aspect, the pressure side and/or suction side of at least one of the blades may be produced by cutting and/or contactless material removal, in particular roughing and/or smoothing, in the slots.

In another aspect, the pressure side and suction side of at least one of the blades may be produced by material removal in encircling fashion.

The present invention also provides a turbomachine rotor, in particular gas turbine rotor, with integrated blades, which turbomachine rotor is manufactured by the method set forth above (including the various aspects thereof), as well as a machine tool for manufacturing the turbomachine rotor. The machine tool comprises a drilling tool for producing the multiplicity of arrangements, which are offset with respect to one another in a circumferential direction, of bores, and a tool for producing the pressure and suction sides of the blades by material removal in the slots formed by the bores.

According to one aspect of the present invention, a method for manufacturing multiple blade channels, which are offset with respect to one another in a circumferential direction, of a turbomachine rotor, in particular of a gas turbine rotor, with integrated blades, in particular of a so-called BLISK, comprises producing or manufacturing a multiplicity of bore arrangements which are offset with respect to one another in the circumferential direction of the rotor, in particular at least two, in particular at least three, bore arrangements that are offset with respect to one another in the circumferential direction of the rotor, proceeding from a radially outer shell surface of the rotor, wherein one or more, in particular all, of the (bore) arrangements of the multiplicity have in each case at least two, in particular at least three bores which, in particular with regard to the central points or axes thereof, are in each case, in particular pairwise, arranged offset with respect to one another in the axial and/or circumferential direction of the rotor, in particular at least substantially equidistantly in the axial and/or circumferential direction of the rotor, in such a way that at least two, in particular at least three, in particular all of the bores of the respective arrangement engage into one another or partially overlap or are superposed on one another in the axial and/or circumferential direction and thus form in each case one slot. In other words, in said step, two or more slots that are offset with respect to one another in the circumferential direction of the rotor are produced or manufactured by way of in each case two or more bores which engage into one another or which partially overlap or are superposed on one another, said bores being produced proceeding from a radially outer shell surface of the rotor.

In this way, in one embodiment, it is advantageously possible for internal stresses, introduced in particular as a result of prior primary forming and/or deformation, for example forging and/or in particular cutting machining such as for example roughing (turning or milling), between blade blanks which are offset with respect to one another in the circumferential direction and which are at least partially separated from one another by the slots to be reduced. In addition or alternatively, by way of the bores, it is possible for material between the blade blanks that are offset with respect one another in the circumferential direction to be removed in advantageous fashion, in particular quickly, easily, reliably in terms of a process and/or inexpensively.

In one embodiment, it is subsequently the case that pressure and suction sides of blades, in particular of finished or finish-machined blades or blade blanks or semifinished parts whose pressure and/or suction sides in one refinement subsequently undergo further machining, in particular undergo final or finish machining, are produced or manufactured by material removal in the slots, in particular by material removal from webs produced by the bores that engage into one another.

In one embodiment, said webs may advantageously support or stirren the blades, which are at least partially separated from one another by the slots, during the production of the pressure and/or suction sides thereof by material removal.

In one embodiment, it is firstly the case that all of the bore arrangements or slots are produced, with the pressure and suction sides of the blades, in particular blade blanks, being produced only thereafter. In this way, internal stresses can particularly advantageously be reduced.

In another embodiment, pressure and suction sides of blades are produced by material removal in already-produced slots (already) before and/or (even) during the manufacture of further bore arrangements or slots. Here, in one refinement, one or more slots, and in each case subsequently pressure and suction sides, are produced in alternation. In another refinement, pressure and suction sides are produced simultaneously or in parallel in already-produced slots and further slots. A manufacture time can particularly advantageously be reduced in this way.

In one embodiment, during the production of the bores and pressure and suction sides, the rotor remains fastened, in particular braced (clamped or chucked), in a machine tool designed for this purpose. A manufacture time can particularly advantageously be reduced in this way.

In one embodiment, a radial height of one or more, in particular all, of the produced bores amounts to at least 75%, in particular at least 90%, in particular at least substantially 100%, of an in particular minimum, maximum and/or mean blade height of an adjacent pressure and/or suction side of the blades. In other words, in one embodiment, one or more, in particular all, bores extend from a blade tip to a blade or blade channel base.

In one embodiment, a spacing of one or more, in particular all, bores, in particular a spacing of the central point(s) or axis (axes) thereof, in the circumferential direction of the rotor from an adjacent pressure side and from an adjacent suction side differs by at most 10%, in particular at most 5%, of the in particular minimum, maximum and/or mean spacing between the adjacent pressure and suction side in the circumferential direction. In other words, said bores are arranged at least substantially equidistantly with respect to the adjacent pressure and suction sides. In this way, a maximum bore radius can advantageously be utilized.

In one embodiment, a diameter of one or more, in particular all, of the bores amounts to at least 30%, in particular at least 50%, in particular at least 75%, of a minimum spacing in the circumferential direction between an adjacent pressure side and suction side. In this way, it is advantageously possible for a maximum bore radius to be utilized. Additionally or alternatively, in one embodiment, the diameter amounts to at most 90%, in particular at most 85%, in particular at most 75%, of the minimum spacing. In this way, it is advantageously possible for material, or an oversize, to be kept available for the material removal process.

In one embodiment, two or more, in particular all bores of one or more, in particular all arrangements have the same diameter. In this way, it is advantageously possible for the same drilling tool to be used. In addition or alternatively, in one embodiment, two or more, in particular all bores of one or more, in particular all arrangements have different diameters. In this way, the bores can advantageously be individually adapted, in particular to blade channels of varying channel width.

In one embodiment, cross sections of two or more, in particular all bores in one or more, in particular all arrangements overlap one another pairwise by at least 10%, in particular at least 25%. In addition or alternatively, the cross sections of two or more, in particular all bores in one or more, in particular all arrangements overlap one another pairwise by at most 90%, in particular at most 50%. In this way, it is possible in particular to realize advantageous material removal, to prevent a drift or deviation of a drilling tool, and/or to produce advantageous webs.

In one embodiment, a drilling axis of a drilling tool during the production of one or more, in particular all bores is inclined by at most 35°, in particular by at most 15°, with respect to a radial direction of the rotor, and/or, during the production of the respective bore, is at least substantially constant or fixed with respect to the rotor. In other words, in one embodiment, one or more, in particular all bores are at least substantially radial bores which are produced from radially outside to radially inside.

In one embodiment, one or more, in particular all bores are produced in a single working step or pass from the radially outer shell surface of the rotor to the bore base, in particular blade channel base, in particular by drilling from radially outside to radially inside, in particular at least substantially as far as the blade (channel) base. Here, in one embodiment, two or more bores of an arrangement and/or bores of two or more arrangements may be produced simultaneously or in parallel or else in succession.

In one embodiment, a bore that is produced first in one or more, in particular all arrangements is produced so as to be spaced apart, in particular at least substantially equally, in an axial direction from mutually oppositely situated face sides of the rotor. In other words, a first bore of at least one of the arrangements is formed in the axial direction of the rotor, at least substantially centrally, between the face sides of said rotor. In another embodiment, a bore that is produced first in one or more, in particular all arrangements is produced in the axial direction at one of the face sides of the rotor.

In one embodiment, one or more, in particular all slots formed by the bores that engage into one another is open in the axial direction of the rotor toward in particular only one face side or toward both of the mutually oppositely situated face sides of the rotor. In this way, material can be removed in an advantageous manner. In another embodiment, one or more, in particular all slots formed by the bores that engage into one another are closed in the axial direction of the rotor toward both of the mutually oppositely situated face sides of the rotor. In this way, in one embodiment, the subsequent material removal in the slot can be improved, in particular an encircling material removal process.

In one embodiment, firstly, at least two slots that are adjacent in the circumferential direction are fully formed or produced by way of the bores that engage into one another, and (only) subsequently, the pressure side and suction side of a blade are produced by material removal in said slots.

In one embodiment, the pressure side and/or suction side of one or more, in particular all blades are/is produced by contactless, in particular electrochemical or spark-erosion and/or cutting material removal, in particular with a geometrically defined and/or undefined cutting edge, in particular by roughing, in particular roughing milling, and/or smoothing, in particular smoothing milling, in the slots.

In one embodiment, the pressure side and/or suction side of one or more, in particular all blades, in particular finished blades or blade blanks, are/is produced by repeated or multi-layer material removal, in one refinement by way of advance and finishing roughing and/or smoothing, in the slots.

In addition or alternatively, the material removal may be performed blockwise or in multi-stage fashion in a radial direction, wherein, in one embodiment, firstly, material removal is performed over at least 25% of a radial length of the bores, and subsequently, in a further stage advanced radially toward the inside, removal is performed over at least a further 25% of the radial length.

In one embodiment, material is firstly removed in multi-layer fashion in a radially outer block, for example by way of advance smoothing (milling) and subsequent smoothing (milling), before material in a further, radially inner block is subsequently removed in multi-layer fashion, for example after radial advancement of the one or more milling cutters. Likewise, it is possible for material to firstly be removed in single-layer fashion in multiple radial blocks successively, for example by advance smoothing (milling) at different radial heights, and for a further material layer to subsequently be removed likewise in multiple radial blocks successively, for example by radial advancement of a smoothing milling cutter.

In one embodiment, the pressure side and suction side of one or more, in particular all blades is produced, in particular over their entire radial height or over a part thereof, by material removal in encircling fashion, in particular by material removal along the pressure side and suction side and along or over a leading and/or trailing edge that connect(s) said pressure side and suction side. Correspondingly, in one embodiment, a leading edge and/or trailing edge, which connects the pressure side and suction side, of one or more, in particular all blades is produced, in particular over their entire radial height or over a part thereof, by the material removal, in particular by material removal in encircling fashion, together with the production of the pressure side and suction side by material removal in the slots. In other words, material removal in encircling fashion for the production of the pressure side and suction side of one or more, in particular all blades may comprise in each case material removal in the two slots adjacent to the pressure side and suction side and one or two axially oppositely situated passing-over movements, with material-removing action, between said two slots.

An in particular computer-controlled machine tool for manufacturing a turbomachine rotor by way of a method described here has a single-part or multi-part drilling tool for producing the multiplicity of arrangements, which are offset with respect to one another in the circumferential direction, of bores and has a single-part or multi-part tool for producing the pressure and suction sides of the blades by material removal in the slots formed by the bores. As stated above, in one refinement, the machine tool has a clamping means to which the rotor is detachably fastened during the production of both the bores and the pressure and suction sides, in particular without detachment between the production of the bores and the production of the pressure and suction sides.

### BRIEF DESCRIPTION OF THE DRAWINGS

Further advantageous refinements of the present invention will emerge from the following description of embodiments of the invention. In the drawings, in part schematically:

FIG. 1 shows a plan view in a radial direction of a part of a gas turbine rotor during a step of a method for manufacturing blade channels according to an embodiment of the present invention;

FIG. 2 shows a plan view corresponding to FIG. 1 during a subsequent step of the method; and

FIG. 3 shows a view in an axial direction of the part of FIG. 2.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

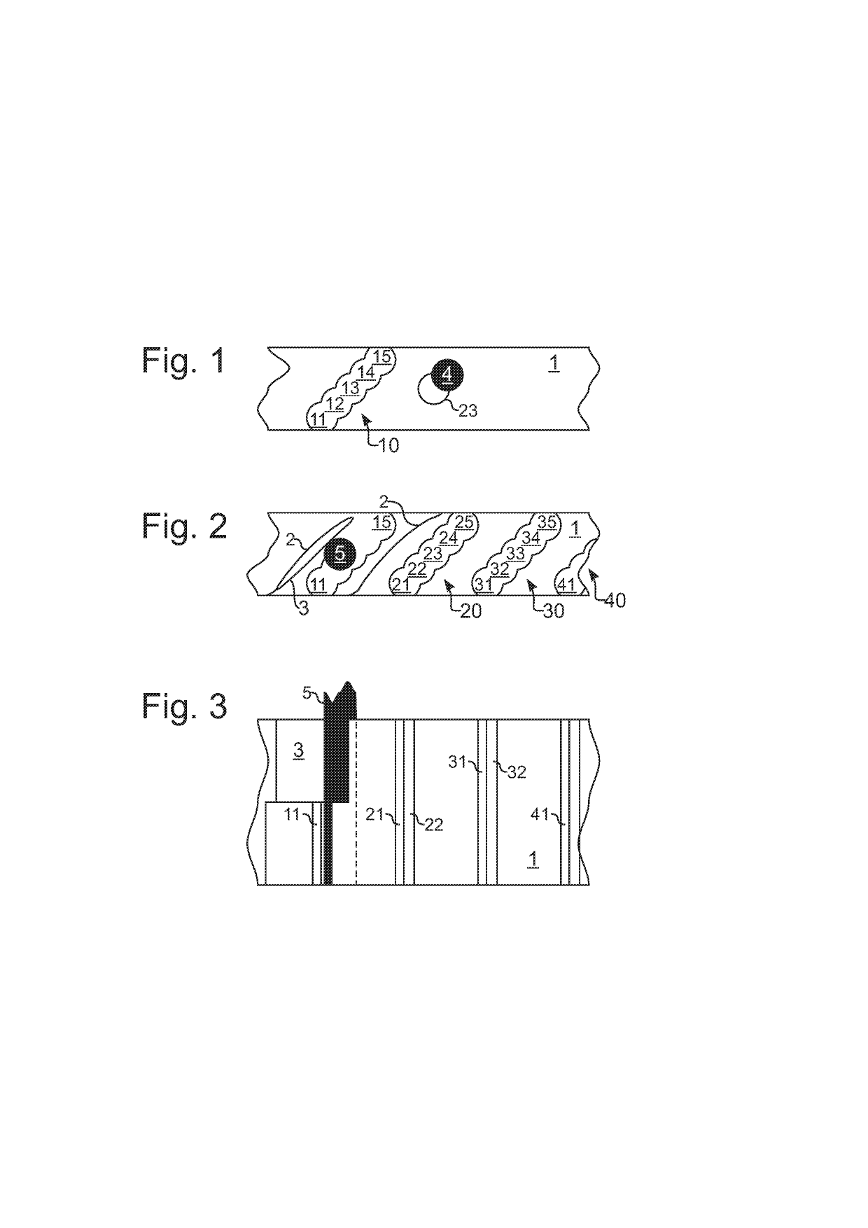

FIG. 1 shows a plan view in a radial direction, from radially outside, of a part of a gas turbine rotor 1 with integrated blades during a step of a method for manufacturing blade channels according to an embodiment of the present invention.

In the step shown in FIG. 1, it is the case, as clarified in particular by a juxtaposition with the later state illustrated in FIG. 2, that a multiplicity of arrangements 10, 20, 30 and 40, which are offset with respect to one another in a circumferential direction (horizontally in FIG. 1 and FIG. 2), of bores 11-41 is produced by way of a drilling tool 4 of a machine tool according to an embodiment of the present invention, wherein the bores 11-15 of the arrangement 10, the bores 21-25 of the arrangement 20, the bores 31-35 of the arrangement 30 and the bores of the arrangement 40 are in each case offset with respect to one another in an axial direction (vertically in FIG. 1 and FIG. 2) and in the circumferential direction such that the bores of an arrangement in each case engage into one another and folin a slot. In the state illustrated in FIG. 1, the bores 11-15 of the arrangement 10 have already been produced and form a slot. The first bore 23 of the arrangement 20 has likewise already been produced, wherein the drilling tool is now producing the bore 24 (cf. FIG. 2).

In the step shown in FIG. 2, suction sides 2 and pressure sides 3 of blades are being produced by material removal in said slots 10, 20, 30 and 40.

For this purpose, firstly, by way of an advance smoothing milling cutter 5, it is the case in particular that the webs that have been produced by the bores are removed in a radially outer half or a radially outer block (at the top in FIG. 3). Subsequently, on the suction side and pressure side, a further material layer is removed in said radially outer block by way of a smoothing milling cutter (not illustrated).

Subsequently, by way of the advance smoothing milling cutter 5, in particular, the webs that have been produced by way of the bores in a radially inner half or a radially inner block (bottom in FIG. 3) are removed. Subsequently, at the suction side and pressure side, a further material layer is removed in said radially inner block by way of the smoothing milling cutter.

In this regard, FIG. 2 and FIG. 3 show, by way of example, a state in which the advance smoothing milling cutter 5 is removing material in the radially inner half of the pressure side 3.

In the exemplary embodiment, the drilling tool 4 produces, proceeding from a radially outer shell surface, bores 11-41 which extend from a blade tip (at the top in FIG. 3) to a blade (channel) base (at the bottom in FIG. 3), such that the radial height of said bores amounts to approximately 100% of the blade height of the adjacent pressure and suction sides 2, 3.

As can be seen in particular in FIG. 2, the bores are situated, in the circumferential direction (horizontally in FIG. 2), approximately in the center between the adjacent pressure and suction sides 2, 3.

The drilling axis (perpendicular to the plane of the drawing of FIG. 2) of the drilling tool 4 is, during the production of the bores 11-41, in each case substantially parallel to a radial direction of the rotor (vertical in FIG. 3), or inclined by approximately 0° with respect to said radial direction.

As can be seen in FIG. 1, a bore 23 that has been produced first in the arrangements 20 is spaced apart approximately equally in the axial direction from mutually oppositely situated face sides of the rotor.

As can be seen in FIG. 2, the slots formed by the bores that engage into one another are open in the axial direction toward both of the mutually oppositely situated face sides of the rotor.

The material removal, in particular the material removal by way of the advance smoothing milling cutter 5 and/or the material removal by way of the smoothing milling cutter may, in one embodiment, be performed in encircling fashion, wherein the respective milling cutter firstly removes material in a slot adjacent to a blade 2, and passes over from said slot, in particular with a material-removing action at a leading edge or trailing edge of the blade, into the slot that is situated opposite the former slot and adjacent to another of the blades, that is to say, for example, in the exemplary embodiment, at the bottom or top in FIG. 2 from the slot formed by the arrangement 20 into the slot formed by the arrangement 10, and, if appropriate at the top or bottom in FIG. 2, from the latter slot back into the slot formed by the arrangement 20, or vice versa.

Even though exemplary embodiments have been discussed in the description above, it is pointed out that numerous modifications are possible. Furthermore, it is pointed out that the exemplary embodiments are merely examples which are not intended to restrict the scope of protection, the uses and the construction in any way. Rather, the above description will provide a person skilled in the art with a guideline for implementing at least one exemplary embodiment, wherein various modifications, in particular with regard to the function and arrangement of the described constituent parts, may be made without departing from the scope of protection as defined by the claims and by said equivalent combinations of features.

### LIST OF REFERENCE NUMBERS

1 Gas turbine rotor
2 Suction side
3 Pressure side
4 Drilling tool
5 Milling cutter
10, 20, 30, 40 (Bore) arrangement/slot
11-41 Bore

What is claimed is:

1. A method for manufacturing blade channels of a turbomachine rotor with integrated blades, wherein the method comprises:
producing a multiplicity of arrangements, which are offset with respect to one another in a circumferential direction, of bores proceeding from a radially outer shell surface of the rotor, at least two bores of at least one arrangement being offset with respect to one another in an axial and/or circumferential direction such that said bores engage into one another and form a slot; and
producing pressure and suction sides of blades by material removal in the slots.

2. The method of claim 1, wherein a radial height of at least one of the produced bores amounts to at least 75% of a blade height of an adjacent pressure and/or suction side of the blades.

3. The method of claim 1, wherein a radial height of at least one of the produced bores amounts to at least 90% of a blade height of an adjacent pressure and/or suction side of the blades.

4. The method of claim 1, wherein a spacing of at least one of the bores in the circumferential direction from an adjacent pressure side and from an adjacent suction side differs by at most 10%.

5. The method of claim 1, wherein a diameter of at least one of the bores is at least 30% and/or at most 90% of a minimum spacing in a circumferential direction between an adjacent pressure side and suction side.

6. The method of claim 1, wherein a diameter of at least one of the bores is at least 50% and/or at most 85% of a minimum spacing in a circumferential direction between an adjacent pressure side and suction side.

7. The method of claim 1, wherein at least two bores of at least one of the arrangements have the same diameter.

8. The method of claim 1, wherein at least two bores of at least one of the arrangements have different diameters.

9. The method of claim 1, wherein cross sections of at least two adjacent bores of at least one of the arrangements overlap one another by at least 10% and/or at most 90%.

10. The method of claim 1, wherein a drilling axis of a drilling tool during the production of at least one of the bores is inclined by at most 35° with respect to a radial direction of the rotor.

11. The method of claim 1, wherein a drilling axis of a drilling tool during the production of at least one of the bores is inclined by at most 15° with respect to a radial direction of the rotor.

12. The method of claim 1, wherein at least one of the bores is produced in a single working step.

13. The method of claim 1, wherein a bore that is produced first in at least one of the arrangements is produced so as to be spaced apart in an axial direction from mutually oppositely situated face sides of the rotor.

14. The method of claim 1, wherein at least one of the slots formed by the bores that engage into one another is open in the axial direction toward one or both of the mutually oppositely situated face sides of the rotor.

15. The method of claim 1, wherein, firstly, at least two slots that are adjacent in the circumferential direction are formed by way of the bores that engage into one another, and subsequently, the pressure side and suction side of a blade are produced by material removal in said slots.

16. The method of claim 1, wherein the pressure side and/or suction side of at least one of the blades is produced by repeated material removal, and/or material removal blockwise in a radial direction, in the slots.

17. The method of claim 1, wherein the pressure side and/or suction side of at least one of the blades is produced by cutting and/or contactless material removal in the slots.

18. The method of claim 1, wherein the pressure side and suction side of at least one of the blades are produced by material removal in encircling fashion.

19. A turbomachine rotor with integrated blades, wherein said turbomachine rotor is manufactured by the method of claim 1.

20. A machine tool for manufacturing the turbomachine rotor of claim 15, wherein the tool comprises a drilling tool for producing the multiplicity of arrangements, which are offset with respect to one another in a circumferential direction, of bores, and a tool for producing the pressure and suction sides of the blades by material removal in the slots formed by the bores.
